(19) United States
(12) Patent Application Publication
(10) Pub. No.: US 2001/0049706 A1
(43) Pub. Date: Dec. 6, 2001

(54) Document indexing system and method

(76) Inventor: John Thorne, Beaconsfield (GB)

Correspondence Address: Kramer Levin Naftalis & Frankel LLP, 919 Third Avenue, New York, NY, 10022, US

(21) Appl. No.: 09/782,124

(22) Filed: Feb. 13, 2001

(30) Foreign Application Priority Data
Jun. 2, 2000 (GB) 0013512.9

(51) Int. Cl. G06F 15/00

(52) U.S. Cl. 707/530

(57) ABSTRACT

A document indexing system, comprising:

a plurality of storage locations (A, B, C) each comprising means for storing, in an electronic form, a plurality of documents;

means (D) for storing document summaries each containing information and/or data derived from a respective one of said documents and link information identifying the document and the storage location from which the summary is derived; and

an application environment operable to run a computer program for searching said stored document summaries for user criteria, and for displaying those document summaries which include said user criteria together with link information corresponding thereto.

### FIELD OF THE INVENTION

This invention relates to document indexing systems, and in particular to systems for indexing documents containing financial and/or business information.

### BACKGROUND TO INVETION

In financial markets, a broker will buy and sell stocks, shares and/or commodities, for example, in dependence upon trends developing in the marketplace to which his traded instrument relates.

As well as watching the markets and following trends, the broker may choose to be more proactive and actively seek to identify new trends, such as stock value changes for example, that might be about to occur.

Information plays a critical role in a broker's ability to identify these new trends, and hence new profit opportunities.

To this end, most broking or investment banking houses produce documents which contain information and/or data, primarily—but not exclusively—of a financial nature, relating to entities (such as individuals, companies, corporations or other business institutions), subjects (such as particular financial instruments) or business areas—for example. Conveniently, these documents are usually in an electronic form so that they are easily transportable.

The documents are then published, either solely for access by employees and/or customers of the broking or investment house which created the document, or for general access by the public.

A problem associated with the publication of these documents is that once the document has been published, control of the information residing therein has been lost Typically, the documents are expensive assets for the broking or investment houses to produce (principally because they represent many hours of employee's time) and they also often contain commercially sensitive information. It can be seen, therefore that it would be desirable for the broking or investment house to be able to control dissemination of the information contained in these documents so that they can protect the investment made, and reduce the likelihood of commercially sensitive material falling into the hands of their competitors.

A number of electronic information systems (such as First Call, Reuters, Dow Jones (Telerate) or Bloomberg for example) have previously been proposed by means of which public documents may be accessed and reviewed.

Bloomberg, for example, allows users to search for documents or other items of information of interest. Bloomberg then displays a list of “hits” identifying those documents of interest, and the user is able to access each of the documents by selecting an item in the list. Once a given document has been selected and viewed, entering a back command returns the user to the list whereupon a new document can be selected.

This process is effective in presenting information to a user, however it can prove to be inconvenient as the process of selecting a document, and then backtracking before selecting a new document can be laborious and time consuming particularly if a large number of documents need to be reviewed. In a broking environment where the markets can move very quickly and the brokers must react very quickly, this delay can prove to be unacceptable.

If a user or broker should choose not to use an information system such as those examples mentioned above (as they might do if the information they require has not been made public, for example), then the broker or user must contact each broking or investment house directly to obtain the information they require. Typically, a broker or user when gathering information will want to review documents from a number of sources, and contacting a number of different institutions directly can prove to be even more time consuming than using one of the aforementioned information systems.

The present invention has been conceived to address one or more of the above mentioned technical problems, and particularly in this respect to improve the speed of information retrieval, to improve information control and/or to improve access to the information.

### SUMMARY OF THE INVENTION

Accordingly, and in accordance with an aspect of the invention, there is provided a document indexing system, comprising:

a plurality of storage locations each comprising means for storing, in an electronic form, a plurality of documents;

means for storing document summaries each containing information and/or data derived from a respective one of said documents and link information identifying the document and the storage location from which the summary is derived; and

an application environment operable to run a computer program for searching said stored document summaries for user criteria, and for displaying those document summaries which include said user criteria together with link information corresponding thereto.

In this way, it is possible for a user to search, at one location, for user criteria in summary information which has been made public, and which relates to a plurality of documents (which may or may not have been made available to the public) stored at one or more of a plurality of alternative locations. The user can review all relevant summary information (i.e. summary information containing the user criteria) retrieved without having to visit each storage location.

Preferably, said document summaries are generated automatically.

Preferably, said document summaries are automatically communicated from said storage locations to said document summary storage means for storage.

Preferably, the system comprises means for establishing, in accordance with said link information, a link to a document of said plurality of documents at a storage location of said plurality of locations.

Preferably, the link information comprises an address which identifies a said storage location, and/or a serial number which identifies a said document at said storage location.

Preferably, the system comprises a telecommunications network for communicating documents between said storage locations and said document summary storage.

Preferably, said telecommunications network comprises an internet.

In one embodiment, the link information may comprise a URL. In which case, it is preferred that said URL is displayed as a hypertext link.

Preferably, the system comprises a plurality of web servers, each of said servers maintaining at least one of said storage locations. In this case, it is preferred that the documents are stored as web pages on said servers.

Preferably, said application environment is maintained by a computer system connectable to said internet, and said computer program comprises a web browser.

In one embodiment, said computer program is operable to display a plurality of indicia that each relate to a respective one of said document summaries that include said user criteria, and a document summary corresponding to a selected one of said indicia Preferably, said indicia comprise navigation tabs displayed on a navigation toolbar. Preferably, the selection of a different indicia causes the corresponding document summary to be displayed. This embodiment is particularly advantageous as it allows a user to quickly switch between summaries without having to backtrack, as they would have to do if they were using the above described prior art systems.

Preferably, one or more of said plurality of storage locations include security means operable to determine whether or not access to a said document should be granted. This is advantageous as it allows the entity controlling the storage locations to control to whom the documents are released.

Preferably, said security means requests an identifier, such as a password or code, before determining whether access to a said document should be granted. Preferably, said security means comprises means for comparing said identifier with a stored identifier, and for granting access to a said document if said identifier matches said stored identifier.

Preferably, said security means comprises computer programs executable in application environments maintained on respective ones of said web servers.

In accordance with a further aspect of the invention, there is provided a method of indexing documents comprising the steps of:

storing a plurality of document summaries that are each derived from a respective document;

searching said plurality of document summaries for those summaries which include user criteria; and

displaying those document summaries which include said user criteria in conjunction with link information identifying respective documents from which those document summaries are derived.

Preferably, said document summaries are stored at a location discrete from one or more other locations at which said documents are stored.

Preferably, said link information identifies the location of said one or more other locations at which said respective documents are stored.

Preferably, said displaying step comprises displaying a plurality of indicia that each relate to a respective one of said document summaries that include said user criteria, and a document summary corresponding to a selected one of said indicia.

Preferably, said indicia comprise navigation tabs displayed on a navigation toolbar.

Preferably, the selection of a different indicia causes the corresponding document summary to be displayed.

A further aspect of the invention provides a computer program product loadable into the memory of a digital computer, comprising one or more software portions for performing one or more of the steps of the method described herein in any combination or permutation when run on a computer.

A further aspect of the invention provides a computer program product embodied upon a computer readable medium.

Another aspect of the invention provides a computer readable medium comprising one or more software portions configured to perform the method described herein when run on a computer.

Another aspect of the invention provides a carrier medium (for example an electromagnetic signal) carrying at least one of said software portions of the computer program.

### BRIEF DESCRIPTION OF THE DRAWINGS

FIG. 1 is a schematic representation of a first embodiment of the invention; and

FIG. 2 is a schematic representation of a computer system;

FIG. 3 is a schematic representation of a second, preferred embodiment of the invention;

FIG. 4 is a schematic representation of a display generated by the system of FIG. 3.

Embodiments of the invention will now be described, by way of example only.

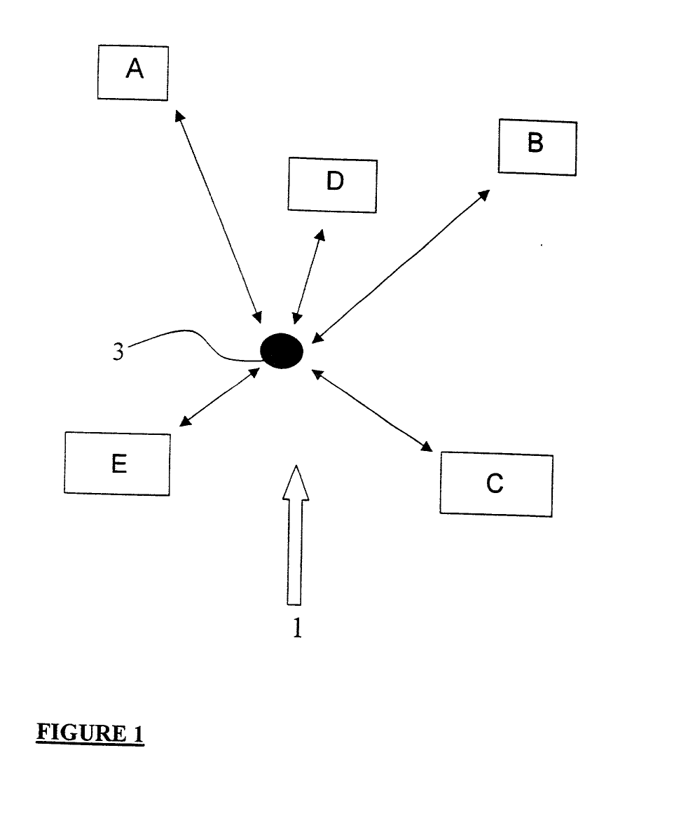

Referring to FIG. 1, the indexing system I of this first embodiment utilises a wired data communications network 3 such as the GNS Dialplus network operated by British Telecommunications plc. It will be appreciated, however, that a wireless data communications network could instead be employed.

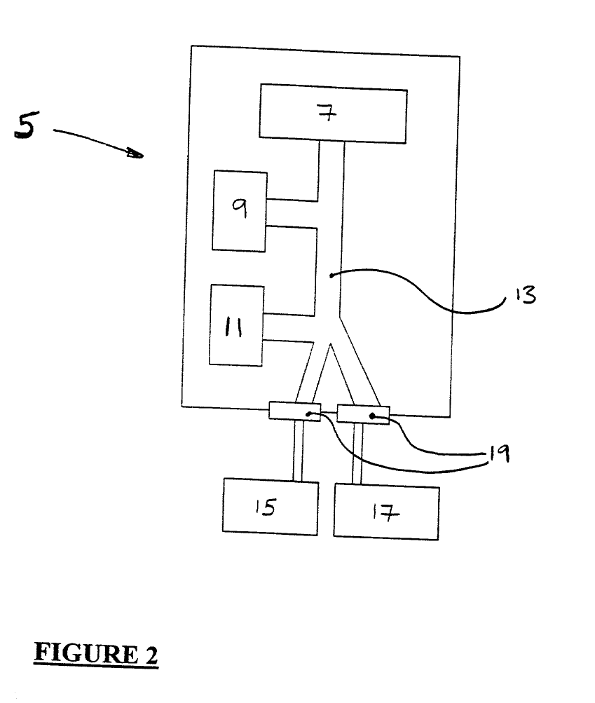

In the illustrative example shown in FIG. 1, the system comprises a database location D, a user location E and three storage locations A,B and C. Referring to FIG. 2, at each location a computer system 5 is provided, and each of these computer systems 5 comprises processing means 7 (for example a CPU or central processing unit), storage means 9 (for example a hard disk), and a communications interface 11 (for example a modem) interconnected by a data bus 13. Peripheral devices, such as for example user input means 15 (for example a keyboard or mouse) or display means 17, are connected to the bus 13 by way of suitable interface ports 19.

In this embodiment, each of the storage locations A, B and C has stored therein a plurality of documents in electronic form. These documents include both those documents which are to be generally available to the public, and those documents to which access is to be restricted.

A document summary, which typically comprises a one, two or three page so-called executive summary of information contained within a given document, is generated for each document stored in the storage locations A, B and C, and these document summaries are transferred to the database location D via the telecommunications network 3, for example, for storage.

The document summaries are stored at the database location D together with link information which, in this embodiment, identifies from which document the document summary is derived as well as the storage location A, B or C where the document is stored. In this embodiment, the link information includes a discrete Network User Address (NUA) which identifies the location where the document is stored, as well as a document identifier (for example a serial number) which identifies the document from which the document summary is derived.

As mentioned above, each location A-E is identified within the network 3 by a discrete Network User Address (or NUA). and upon connection to the network a calling party is prompted to enter the NUA of the entity or location to which they wish to connect.

If a user wishes to obtain information from the database location D, they enter (when prompted) the NUA of the database location and the network 3 then establishes a communications link between the user location E and the database location D.

Once the link has been established to the database location, the user of the computer system at the user location E may search through document summary information stored at the database location D for document summaries which contain user criteria, such as for example a particular company name, a particular individual name or a particular financial instrument.

The computer system at the database location D will then process the query from the user and generate a set of document summaries which include the user criteria (which set may include none, one or many document summaries).

The document summary set generated at the database location is then available for viewing and review by the user over the communications link between the user location E and the database location D.

This link information is provided to the user (together with each document summary) so that the user can review—should they wish to—all of the document for any document summaries which might be of interest. As mentioned above, the link information identifies from which document the document summary is derived as well as the storage location A, B or C where the document is stored.

To implement this feature, the user must note the link information for those items of interest, and then terminate the connection between the network 3 and the database location D.

Upon termination of the connection, the network 3 prompts the user to input an NUA and the user must input the NUA of the location to which they wish to connect. The network 3 then establishes a connection to the location of interest, and the user is prompted to input the document identifier so that the appropriate document can be retrieved.

At this point, the user may be required to input security information, such as a password for example, before the storage location will display the requested document. As a result, it is possible for distribution of documents to be controlled, and limited to those users who have the appropriate authorisation.

After the documents requested have been reviewed, and maybe printed, the user can then log out of that storage location whereupon the user will be prompted to enter the NUA of another storage location. The user can then either input the NUA requested, or alternatively disconnect from the network 3 to terminate the session.

In a modification of this embodiment, it is conceivable that the user could be automatically connected to the storage location from which a given document is derived simply by selecting the corresponding link information.

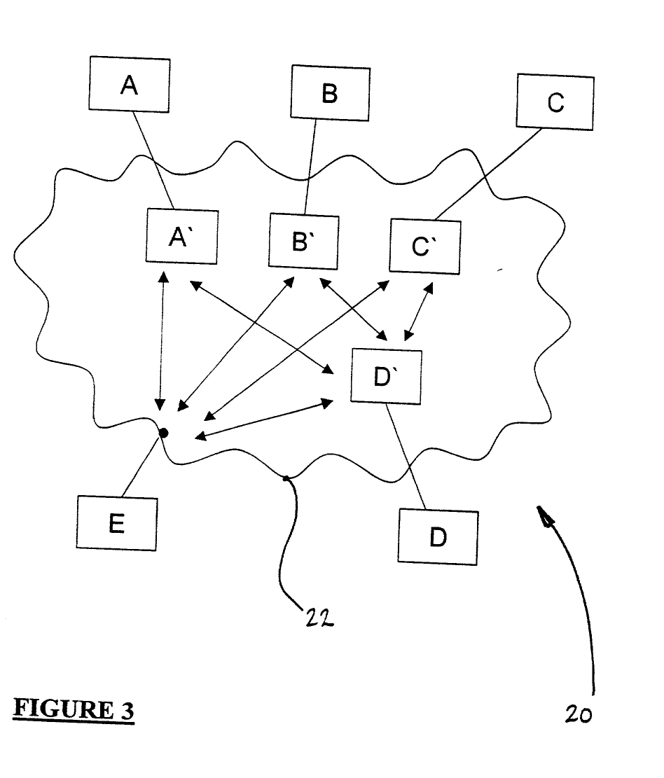

A further embodiment of the invention will now be described with reference to FIG. 3. This second embodiment is implemented via an internet.

FIG. 3 is a schematic representation of an internet based document indexing system 20. As shown, the system comprises storage locations A, B and C, a database location D and a user location E. As with the first embodiment, each of the locations A to E comprise a computer system which may have the features of the system described in relation to FIG. 2.

The computer systems at each location are connectable to an Internet 22, and each of the storage location systems and the database location system run software which is configured to establish websites A′ to D′ on the Internet 22 (for example, locations A to D may be web servers).

A user at the user location E can log onto (i.e. connect to) the Internet 22 and subsequently to any of the storage locations A to C or to the database location D via their respective websites A′ to D′.

Each of the storage location websites A′ to C′ include a plurality of webpages, and each webpage includes the information, text and/or data of a given document. As with the first embodiment summary information derived from each document is transferred via the database location website D′ for storage on the database location computer system.

Preferably, the database location website D′ is continuously updated with new summary information as new documents are stored at the storage locations A to C. This updating process may be automated so that the first page, for example, of any new document is automatically transferred to the database location D′, or alternatively the updating process may require operator intervention and initiation.

As with the first embodiment, each document summary (i.e. each webpage) includes link information which comprises, in this embodiment, a hypertext link to the document (and/or to the location) from which the summary is derived. The hypertext link conveniently comprises a Universal Resource Locator (or URL), and by selecting the hypertext link a connection will be established directly to the location where the document is stored, and preferably directly to the document itself.

From the above, it will be seen that a user can connect to the database location website D′ and conduct a search (using, for example, a browser running on the user location computer system) through the document summaries stored therein for user specified criteria. The database location website D′ will present the results of the search as a display of document summaries which include the user specified criteria (i.e. relevant document summaries). and the user can follow hypertext links embedded in those summaries directly to the website (i.e. to the storage location), and preferably directly to the document, from which the document summary in question is derived.

When the user attempts to read a given document from one of the storage locations, a security application may be executed to prevent the user gaining sight of the document in question until a correct authorisation code, password or other identifier has been inputted. In this way, it is possible for distribution of documents to be controlled, and limited to those users who have the appropriate authorisation. However, it should be noted that a user will always be able to view document summary information and that it is only access to the full document (at the storage locations) that may be denied.

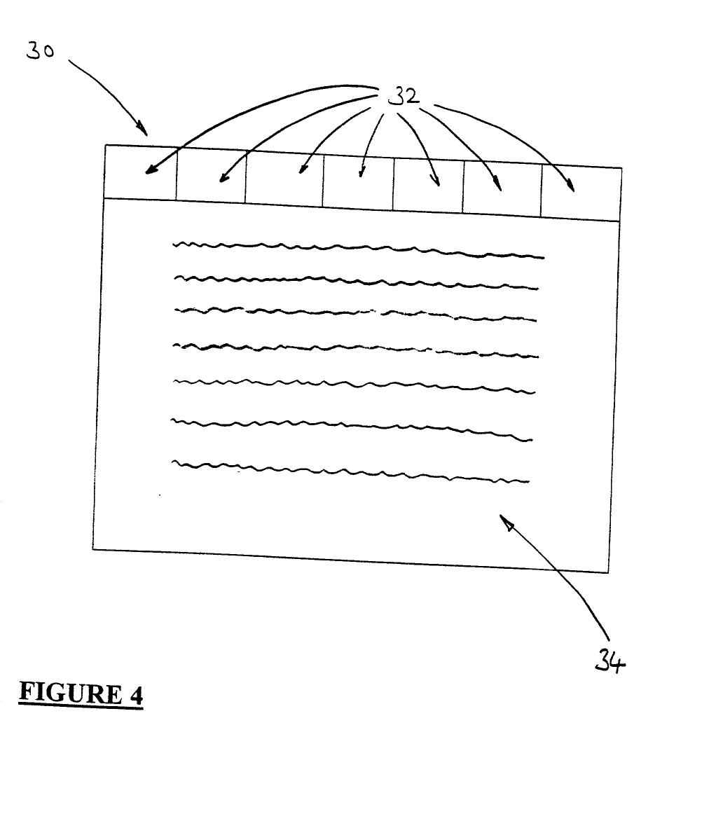

In a highly preferred embodiment, the display of relevant document summaries is achieved in accordance with the screen display format depicted schematically in FIG. 4 which illustrates an illustrative display that one might see at the display means of the user computer system, for example.

As mentioned above, one problem with existing systems is that they can be inconvenient to operate as they require a large amount of backtracking between individual document summaries and lists of relevant document summaries. The arrangement of FIG. 4 aims to avoid this situation by providing a display which includes a navigation toolbar 30 that comprises a plurality of navigation tabs 32.

Each navigation tab is associated with one of the relevant document summaries previously identified in the search, and includes information that identifies the document to which it relates. Beneath the navigation toolbar 30 is a display area 34 in which relevant document summaries are displayed one at a time. Selecting a given navigation tab (by positioning a cursor over the tab and clicking a mouse button for example) causes the document summary associated with that tab to be displayed in the display area 34 beneath the toolbar 30.

In this way it is possible for the user to quickly switch between relevant document summaries by clicking on the navigation tabs 32 without having to return each time to a list of the document summaries found. As a consequence, the time taken to review the relevant document summaries can be reduced.

It will be understood, of course, that modifications may be made within the scope of the invention.

One advantage provided by the present invention is that one or more software portions operable to perform the method described herein may be distributed on a computer readable medium (for example a floppy disk, or a compact disk) or alternatively or additionally by electronic means (for example by e-mail, electronic file transfer or by way of an electromagnetic signal).

1. A document indexing system, comprising:
a plurality of storage locations each comprising means for storing, in an electronic form, a plurality of documents;
means for storing document summaries each containing information and/or data derived from a respective one of said documents and link information identifying the document and the storage location from which the summary is derived; and
an application environment operable to run a computer program for searching said stored document summaries for user criteria, and for displaying those document summaries which include said user criteria together with link information corresponding thereto.

2. A system according to claim 1, wherein said document summaries are generated automatically.

3. A system according to claim 1, wherein said document summaries are automatically communicated from said storage locations to said document summary storage means for storage.

4. A system according to claim 1, comprising means for establishing, in accordance with said link information, a link to a document of said plurality of documents at a storage location of said plurality of locations.

5. A system according to claim 1, wherein said link information comprises an address which identifies a said storage location.

6. A system according to claim 5, wherein said link information comprises a serial number which identifies a said document at said storage location.

7. A system according to claim 1, comprising a telecommunications network for communicating document summaries between said storage locations and said document summary storage.

8. A system according to claim 7 when dependent upon any of claims 1 to 3, wherein said telecommunications network comprises an internet.

9. A system according to any of claim 8, wherein said link information comprises a URL.

10. A system according to claim 9, wherein said URL is displayed as a hypertext.

11. A system according to claim 8, comprising a plurality of web servers, each of said servers maintaining at least one of said storage locations.

12. A system according to claim 11, wherein said documents are stored as web pages on said servers.

13. A system according to claim 7, wherein said application environment is maintained by a computer system connectable to said internet, and said computer program comprises a web browser.

14. A system according to claim 1, wherein said computer program is operable to display a plurality of indicia that each relate to a respective one of said document summaries that include said user criteria, and a document summary corresponding to a selected one of said indicia.

15. A system according to claim 14, wherein said indicia comprise navigation tabs displayed on a navigation toolbar.

16. A system according to claim 14, wherein the selection of a different indicia causes the corresponding document summary to be displayed.

17. A system according to claim 1, wherein one or more of said plurality of storage locations include security means operable to determine whether or not access to a said document should be granted.

18. A system according to claim 17, wherein said security means requests an identifier, such as a password or code, before determining whether access to a said document should be granted.

19. A system according to claim 18, wherein said security means comprises means for comparing said identifier with a stored identifier, and for granting access to a said document if said identifier matches said stored identifier.

20. A system according to claim 17, when dependent upon claim 11, wherein said security means comprises computer programs executable in application environments maintained on respective ones of said web servers.

21. A method of indexing documents comprising the steps of:
storing a plurality of document summaries that are each derived from a respective document;
searching said plurality of document summaries for those summaries which include user criteria; and
displaying those document summaries which include said user criteria in conjunction with link information identifying respective documents from which those document summaries are derived.

22. A method according to claim 21, wherein said document summaries are stored at a location discrete from one or more other locations at which said documents are stored.

23. A method according to claim 22, wherein said link information identifies the location of said one or more other locations at which said respective documents are stored.

24. A method according to claim 21, wherein said displaying step comprises displaying a plurality of indicia that each relate to a respective one of said document summaries that include said user criteria, and a document summary corresponding to a selected one of said indicia.

25. A method according to claim 24, wherein said indicia comprise navigation tabs displayed on a navigation toolbar.

26. A method according to claim 24, wherein the selection of a different indicia causes the corresponding document summary to be displayed.

27. A computer program product loadable into the memory of a digital computer, comprising one or more software portions for performing one or more of the steps of the method according to claim 21, in any combination or permutation when run on a computer.

28. A computer program product according to claim 27 embodied upon a computer readable medium.

29. A computer readable medium comprising one or more software portions configured to perform the method of claim 21, when run on a computer.

30. A carrier medium (for example an electromagnetic signal) carrying at least one of said software portions of the computer program of claim 27.

31. A carrier medium carrying machine readable instructions for configuring a computer to perform the step of:
storing a plurality of document summaries that are each derived from a respective document;
searching said plurality of document summaries for those summaries which include user criteria; and
displaying those document summaries which include said user criteria in conjunction with link information identifying respective documents from which those document summaries are derived.
